(19) United States
(12) Patent Application Publication
(10) Pub. No.: US 2011/0098432 A1
(43) Pub. Date: Apr. 28, 2011

(54) Coordination Complex

(76) Inventors: Edward Marshall, Surrey (GB); John Anthony Segal, Hertfordshire (GB); Vernon Charles Gibson, London (GB)

(21) Appl. No.: 10/501,684

(22) PCT Filed: Jan. 16, 2003
(86) PCT No.: PCT/GB2003/000163

§ 371 Date: Nov. 13, 2006

(30) Foreign Application Priority Data
Jan. 18, 2002 (GB) 0201141.9

(51) Int. Cl. C08F 4/50; C07F 3/02; C07F 5/02; C07F 3/04

(52) U.S. Cl. 526/183; 564/271; 564/276; 548/110; 526/204

(57) ABSTRACT

The present invention provides a complex of formula I

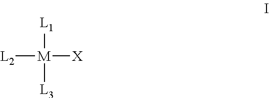

wherein

M is Ca, Mg, Ba or Sr;

L₁ is selected from R¹O, R²S, R³R⁴N, R⁵R⁶P, a substituted or unsubstituted cyclopentadienide, and a substituted or unsubstituted pyrazolyl group, where R¹⁻⁶ are each independently H or hydrocarbyl;

L₂ is selected from R⁷R⁸O, R⁷R⁸S, R⁷R⁸R⁹N, R⁷R⁸C═NR⁹, PR⁷R⁸R⁹, and a substituted or unsubstituted heterocycle containing one or more O, N or S atoms, where R⁷⁻⁹ are each independently H or a hydrocarbyl group; or L₁ and L₂ are linked to form a bidentate ligand;

L₃ is absent or is a solvent molecule, or a neutral ligand as defined for L₂, wherein L₃ may be the same or different to L₂; or L₃ is linked to a further metal centre; or L₁, L₂ and L₃ are linked to form a tridentate ligand; and

X is an alkyl group, an aryl group, an aryloxide, an amide group, or an enolate group of formula R¹⁰R¹¹C═CR¹²O—, wherein R¹⁰⁻¹² are each independently H or hydrocarbyl;

with the proviso that when L₁ and L₂ are {HC(C(CH₃)═N-2,6-ⁱPr₂C₆H₃)₂} and M is magnesium, X is other than Me or ^{t}Bu.

The present invention relates to a series of discrete, well-defined coordination complexes. More specifically, the invention concerns the use of Group 2 metal complexes in the controlled polymerisation of acrylate and alkylmethacrylate monomers.

Over recent years, an important technological objective has been the controlled, ‘living’ polymerisation of acrylate and alkylmethacrylate monomers to give products of controlled molecular weight and molecular weight distribution, and to provide access to block co-polymer materials. Examples of controlled or ‘living’ polymerisations include anionic polymerisation [C. Zune, R. Jêrôme, Prog. Polym. Sci., 1999, 24, 631], group transfer polymerisation [O. W. Webster, W. R. Herder, D. Y. Sogah, W. B. Farnham, T. V. Rajanbabu, J. Am. Chem. Soc., 1983, 105, 5706], atom transfer radical polymerisation [K. Matyjaszewski, J. Xia, Chem. Rev., 2001, 101, 2921], immortal polymerisation [T. Aida, S. Inoue, Acc. Chem. Res., 1996, 29, 39], catalytic chain transfer polymerisation [T. P. Davis, D. M. Haddleton, S. N. Richards, J. Macromol. Sci. Rev. Macromol. Chem. Phys., 1994, C34, 243], screened anionic polymerisation [D. G. H. Ballard, R. J. Bowles, D. M. Haddleton, S. N. Richards, R. Sellens, D. L. Twose, Macromolecules, 1992, 25, 5907] and metal-free anionic polymerisations [M. T. Reetz, Angew. Chem., Int. Ed. Engl. 1988, 27, 994].

Stereospecific polymers can exist in two different forms, isotactic and syndiotactic, as shown below.

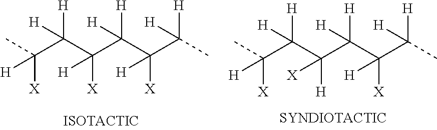

By way of contrast, an atactic polymer is one that has no regular arrangement along the chain.

Another important objective in the field of polymer chemistry has been to develop systems that can control the tacticity of products such as polymethylmethacrylate under industrially relevant process conditions. For example, the higher softening temperature accompanying highly syndiotactic polymethylmethacrylate confers beneficial properties on the resultant materials. Examples include s-PMMA for injection molding, artificial marble pre-mixes, stereocomplexes for preparing membranes and/or gel base materials, and syndiotactic-isotactic block PMMA for forming resist patterns.

To date, a number of systems have been described that can effect syndiotactic control in polymethylmethacrylate. These include organolanthanides [H. Yasuda, H. Yamamoto, K. Yokota, S. Miyake and A. Nakamura, J. Am. Chem. Soc., 1992, 114, 4908; M. Nodono, T. Tolcimitsu, S. Tone, T. Makino and A. Yanogase, Macromol. Chem. Phys., 2000, 201, 2282], zirconocenes [A. D. Bolig and E. Y. -X. Chen, J. Am. Chem. Soc., 2001, 123, 7943] aluminium compounds [T. Kitayama, T. Shinozaki, T. Sakamoto, M. Yamamoto and K. Hatada, Makromol. Chem. Suppl., 1989, 15, 167; G. L. N. Peron, R. J. Peace and A. J. Holmes, J. Mater. Chem., 2001, 11, 2915], magnesium compounds [T. Kitayama, T. Shinozaki, E. Masuda, M. Yamamoto and K. Hatada, Polym. Bull., 1988, 20, 565] and enamine initiators [M. Miyamoto and S. Kanetaka, J. Polym. Sci.: Part A: Polym. Chem., 1999, 37, 3671]. Most of these systems are accompanied by one or more limitations: either exceptionally low temperatures (e.g. −78° C. or below) are required to obtain high syndiotacticity, and/or the molecular weight control over the resultant product is poor.

The present invention thus seeks to provide a series of discrete, well-defined coordination complexes that are useful as initiators in the polymerisation of alkylacrylate and/or alkylmethacrylate monomers. More specifically, the invention seeks to provide coordination complexes that are capable of influencing and/or controlling the syndiotacticity of the resulting polymer but which alleviate some of the above-mentioned problems associated with prior art complexes.

In a first aspect, the invention provides a complex of formula I

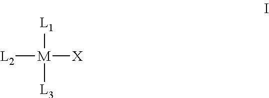

wherein

M is Ca, Mg, Ba or Sr;

L₁ is selected from R¹O, R²S, R³R⁴N, R⁵R⁶P, a substituted or unsubstituted cyclopentadienide, and a substituted or unsubstituted pyrazolyl group, where R¹⁻⁶ are each independently H or hydrocarbyl;

L₂ is selected from R⁷R⁸O, R⁷R⁸S, R⁷R⁸R⁹N, R⁷R⁸C═NR⁹, PR⁷R⁸R⁹, and a substituted or unsubstituted heterocycle containing one or more O, N or S atoms, where R⁷⁻⁹ are each independently H or a hydrocarbyl group; or L₁ and L₂ are linked to form a bidentate ligand;

L₃ is absent or is a solvent molecule, or a neutral ligand as defined for L₂, wherein L₃ may be the same or different to L₂; or L₃ is linked to a further metal centre; or L₁, L₂ and L₃ are linked to form a tridentate ligand; and

X is an alkyl group, an aryl group, an amide group, an aryloxide or an enolate group of formula R¹⁰R¹¹C═CR¹²O—, wherein R¹⁰⁻¹² are each independently H or hydrocarbyl;

with the proviso that when L₁ and L₂ are {HC(C(CH₃)═N-2,6-ⁱPr₂C₆H₃)₂} and M is magnesium, X is other than Me or ^{t}Bu.

In a first aspect, the present invention therefore relates to a complex wherein L₁ is a monoanionic ligand, and L₂ and L₃, if present, are both neutral ligands.

Thus, where L₁ is a substituted or unsubstituted cyclopentadienide, this refers to a monoanionic substituted or unsubstituted cyclopentadiene nucleus which complexes to the metal M. Likewise, where L₁ is a substituted or unsubstituted pyrazolyl group, this refers to a monoanionic pyrazole nucleus. Preferably, the monoanionic pyrazole nucleus complexes to the metal, M, through one of the nitrogen atoms.

As used herein, the term “hydrocarbyl” refers to a group comprising at least C and H that may optionally comprise one or more other suitable substituents. Examples of such substituents may include halo-, alkoxy-, nitro-, an alkyl group, or a cyclic group. In addition to the possibility of the substituents being a cyclic group, a combination of substituents may form a cyclic group. If the hydrocarbyl group comprises more than one C then those carbons need not necessarily be linked to each other. For example, at least two of the carbons may be linked via a suitable element or group. Thus, the hydrocarbyl group may contain heteroatoms. Suitable heteroatoms will be apparent to those skilled in the art and include, for instance, sulphur, nitrogen, oxygen, phosphorus and silicon.

Preferably, M is Ca or Mg.

In a preferred embodiment, R¹ and R² are each independently hydrocarbyl, and R³⁻⁶ are each independently H or hydrocarbyl.

In a particularly preferred embodiment, R¹ and R² are each independently selected from branched or unbranched alkyl, branched or unbranched alkenyl, or aryl, each of which may be substituted or unsubstituted. Suitable substituents include, for example, alkyl, halo-, alkoxy-, nitro-, or a cyclic group.

As used herein, the term “alkyl” refers to a saturated carbon-containing chain which may be straight or branched, and substituted (mono- or poly-) or unsubstituted. Suitable substituents include those which do not have any significant adverse effect on the activity of the complex and may include, for example, halo-, alkoxy-, nitro-, or a cyclic group.

Preferably, the alkyl group is a C₁₋₂₀ alkyl group, more preferably a C₁₋₁₀ alkyl group.

Accordingly, the term “haloalkyl” refers to an alkyl group substituted by at least one halogen, for example, chlorine, bromine, fluorine or iodine.

Accordingly, the term “heteroalkyl” refers to an alkyl group containing at least one heteroatom, for example, O, N or S.

As used herein, the term “alkenyl” refers to a C₂₋₂₀ unsaturated carbon-containing chain which may be branched or unbranched, and substituted (mono- or poly-) or unsubstituted. Preferably the alkenyl group is a C₂₋₁₀ alkenyl group.

As used herein, the term “aryl” refers to a C₆₋₁₀ aromatic, substituted (mono- or poly-) or unsubstituted. Again, suitable substituents include those which do not have any significant adverse effect on the activity of the complex and may include, for example, alkyl, halo-, allcoxy-, nitro-, or a cyclic group.

As used herein, the term “cycloalkyl” refers to a cyclic alkyl group which may be substituted (mono- or poly-) or unsubstituted.

As used herein, the term “heterocycle” refers to an aromatic or non-aromatic heterocycle comprising one or more heteroatoms. Preferred heterocycle groups include pyrrole, pyrazole, pyrimidine, pyrazine, pyridine, quinoline, thiophene and furan.

In one preferred embodiment, X is an alkyl group. In an especially preferred embodiment, X is ⁱPr.

In another preferred embodiment, X is an amide group. Even more preferably, X is NPrⁱ₂.

In another preferred embodiment, X is an enolate group of formula R¹⁰R¹¹C═CR¹²O—, wherein R¹⁰⁻¹² are each independently H or hydrocarbyl. Preferably, R¹⁰ and R¹¹ are H and R¹² is an aryl group.

In one particularly preferred embodiment, X is —OC(═CH₂)Ar, wherein Ar=2,4,6,-Me₃C₆H₂.

In one preferred embodiment, L₃ is THF or Et₂O.

In another preferred embodiment, L₁ and L₂ are linked to form a bidentate ligand selected from derivatives of acetylacetonate, e.g. a beta-diketiminate or a beta-ketoiminate.

In one preferred embodiment, the complex of the invention is of formula II or III

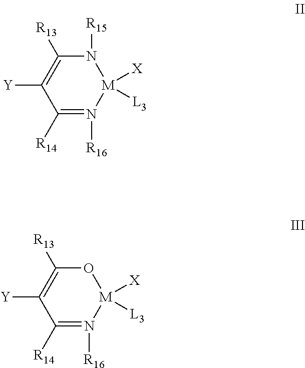

wherein

Y is H, halogen, NO₂, hydrocarbyl or CN;

R¹³⁻¹⁶ are each independently selected from H and hydrocarbyl; or Y and R¹³ are linked to form a hydrocarbyl group; and

L₃ is as defined above.

The skilled person will appreciate that ligands of formula III will have an overall charge of −1 and may exist in one or more of the isomeric forms shown below, or mixtures thereof, or a hybrid thereof in which the electrons are delocalised throughout the whole ligand system.

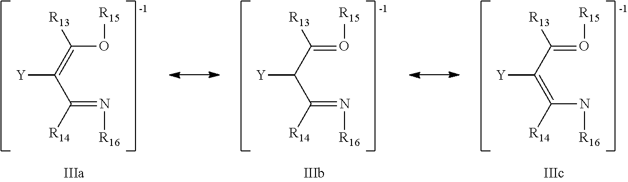

Likewise, the skilled person will appreciate that ligands of formula II will have an overall charge of −1 and may exist in one or more of the isomeric forms shown below, or mixtures thereof, or a hybrid thereof in which the electrons are delocalised throughout the whole ligand system.

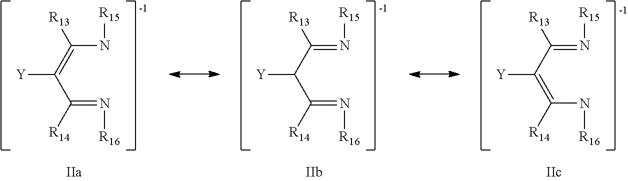

As used herein, and throughout the accompanying claims and Examples, the shorthand representation of the di-imine isomer IIb, {YC(C(R′)═N—R″)₂}, is used for simplicity to represent all of the above isomeric forms of ligand II, in the case where R¹³ and R¹⁴ are the same (represented as R′) and R¹⁵ and R¹⁶ are the same (represented as R″).

In a more preferred embodiment, where the complex of the invention is of formula II or III, Y is selected from H, halogen, NO₂, CN, alkyl, aryl, haloalkyl or heteroalkyl; R¹³⁻¹⁶ are each independently selected from alkyl, aryl, heteroallcyl, haloalkyl, cycloalkyl and a heterocyclic ring containing at least one O, N or S atom; or Y and R¹³ are linked to form an aryl group; and

L₃ is selected from R⁷R⁸O, R⁷R⁸S, R⁷R⁸R⁹N, R⁷C═NR⁸, PR⁷R⁸R⁹, thiophene and tetrahydrofuran, where R⁷⁻⁹ are each independently H or a hydrocarbyl group.

Preferably, where the complex of the invention is of formula II or III, R¹³ and R¹⁴ are each independently alkyl. In one especially preferred embodiment, R¹³ and R¹⁴ are the same. More preferably still, R¹³ and R¹⁴ are both methyl or are both ^{t}Bu.

Preferably, where the complex of the invention is of formula II or III, R¹⁵ and R¹⁶ are each substituted aryl groups. In one especially preferred embodiment, R¹⁵ and R¹⁶ are the same. More preferably still, R¹⁵ and R¹⁶ are both 2,6-diisopropylphenyl.

In another preferred embodiment, the complex of the invention is of formula V

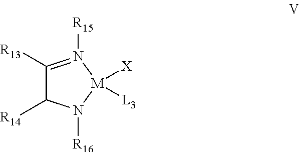

wherein R¹³⁻¹⁶ are as defined above, and where R¹³ and R¹⁵ are optionally linked to form an aryl group.

Preferably, where the complex of the invention is of formula V, R¹³ and R¹⁴ are the same.

Preferably, where the complex of the invention is of formula V, R¹⁵ and R¹⁶ are the same.

In one preferred embodiment of the invention, L₁, L₂ and L₃ are linked to form a tridentate ligand.

In a particularly preferred embodiment, L₁, L₂ and L₃ are linked to form a tridentate ligand selected from a beta-diketiminate with a pendant donor group, a Schiff base derivative with a pendant donor arm, and a tris(pyrazolyl)borate ligand.

Even more preferably, the complex of the invention is of formula

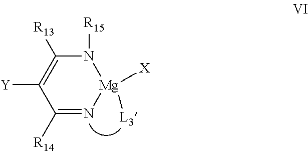

wherein L₃′ is defined as for L₃ above, and is linked to the nitrogen of the bidentate ligand via a linker group.

More preferably, the linker group is an aryl group.

In one particularly preferred embodiment, L_{3′} is an alkoxy group. Even more preferably, the alkoxy group L_{3′} is attached to an aryl linker group.

In the case where the complex is of formula VI, preferably Y is H, R¹³ and R¹⁴ are both methyl, R¹⁵ is aryl (preferably 2,6-diisopropylphenyl) and X is isopropyl.

In an alternative preferred embodiment, the complex of the invention is of formula VII

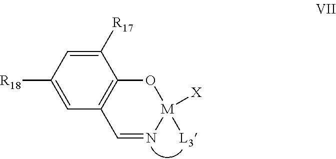

wherein L₃′ is defined as for L₃ above, and is linked to the nitrogen of the bidentate ligand via a linker group, and R¹⁷⁻¹⁸ are as defined for R¹³⁻¹⁶ above.

Preferably, where the complex is of formula VI or VII, the linker group is (CH₂)ₙ where n is 0-6, an arylene group, or SiR₂, where R is a hydrocarbyl group.

In another preferred embodiment of the invention, L₁, L₂ and L₃ are linked to form a tris(pyrazolyl)borate ligand which complexes to metal M as shown below, where each R is independently H or a hydrocarbyl group.

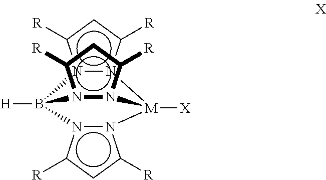

The tris(pyrazolyl)borate ligand has an overall charge of −1, i.e., one of the pyrazolyl groups bonds to the metal M as a monoanionic ligand (L₁), whereas the remaining two pyrazolyl groups (L₂, L₃) complex to metal M as neutral ligands. However, the skilled artisan will appreciate that the electrons in the above tris(pyrazolyl)borate complex are delocalised throughout the whole system.

In yet another preferred embodiment of the invention, L₁ and L₂ form a bidentate ligand of formula VIII

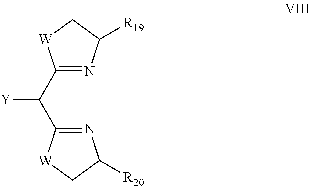

wherein

Y is as defined above;

W is O, NH, NR′″ or CH₂, where R′″ is a hydrocarbyl group; and

R¹⁹⁻²⁰ are as defined for R¹³⁻¹⁶ above.

The skilled person will appreciate that the ligand of formula VIII will have an overall charge of −1 and may exist in one or more of the isomeric forms shown below, or mixtures thereof.

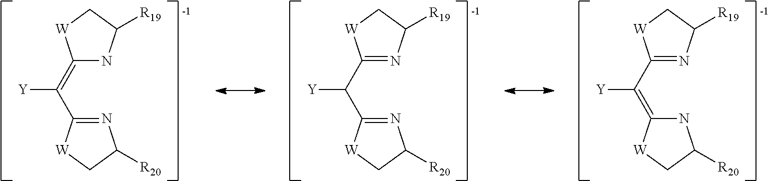

In one preferred embodiment, the invention comprises a dimer of a complex as described hereinbefore, or higher nuclearity aggregates.

In an especially preferred embodiment, the complex of the invention is selected from the following:

{HC(C(CH₃)═N-2,6-ⁱPr₂C₆H₃)₂}MgⁱPr [1];

[55 HC(C(CH₃)═N-2,6-ⁱPr₂C₆H₃)₂}Mg(OC(═CH₂)Ar)]₂ [2];

[{HC(C(CH₃)═N-2,6-ⁱPr₂C₆H₃)₂}Mg(OC(═CH2)Ar).Et₂O] [3];

wherein Ar=2,4,6,-Me₃C₆H₂;

{HC(C(^{t}Bu)═N-2,6-ⁱPr₂C₆H₃)₂}Mg(OC(═CH₂)-2,4,6-Me₃C₆H₂) [4];

{HC(C(Me)═N-2,6-ⁱPr₂C₆H₃)(C(Me)═N-2-OMeC₆H₄)}MgⁱPr [5];

{HB(3,5-Me₂C₃N₂H)₃}Mg(OC(═CH₂)-2,4,6-Me₃C₆H₂) [6];

{HC(C(Me)═N-2,6-ⁱPr₂C₆H₃)₂}Ca(OC(═CH₂)-2,4,6-Me₃C₆H₂).THF [7];

[{HC(C(Me)═N-2,6-ⁱPr₂C₆H₃)₂}Ca(OC(═CH₂)-2,4,6-Me₃C₆H₂)]ₙ [8] where n=1 or 2; and

{HC(C(CH₃)═N-2,6-ⁱPr₂C₆H₃)₂}MgNPrⁱ₂ [9].

In a second aspect, the invention relates to the use of a complex of formula Ia as a polymerisation initiator,

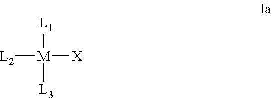

wherein

M is Ca, Mg, Ba or Sr;

L₁ is selected from R¹O, R²S, R³R⁴N, R⁵R⁶P, a substituted or unsubstituted cyclopentadienide, and a substituted or unsubstituted pyrazolyl group, where R¹⁻⁶ are each independently H or hydrocarbyl;

L₂ is selected from R⁷R⁸O, R⁷R⁸S, R⁷R⁸R⁹N, R⁷R⁸C═NR⁹, PR⁷R⁸R⁹, and a substituted or unsubstituted heterocycle containing one or more O, N or S atoms, where R⁷⁻⁹ are each independently H or a hydrocarbyl group; or L₁ and L₂ are linked to form a bidentate ligand;

L₃ is absent or is a solvent molecule, or a neutral ligand as defined for L₂, wherein L₃ may be the same or different to L₂; or L₃ is linked to a further metal centre; or L₁, L₂ and L₃ are linked to form a tridentate ligand; and

X is an alkyl group, an aryl group, an amide group, or an enolate group of formula R¹⁰R¹¹C═CR¹²O—, wherein R¹⁰⁻¹² are each independently H or hydrocarbyl;

with the proviso that when L₁ and L₂ are {HC(C(CH₃)═N-2,6-ⁱPr₂C₆H₃)₂}, M is magnesium, X is other than Me or ^{t}Bu.

Preferably, M is Ca or Mg.

The preferred embodiments for the second aspect of the invention are identical to those described hereinabove for the first aspect.

In a preferred embodiment, the invention relates to the use of a complex of formula Ia in the polymerisation of acrylate and/or alkylacrylate monomers. In particular, the complexes of the present invention are capable of influencing the tacticity of the resulting polymer. More specifically, the complexes of the invention are capable of inducing a high degree of syndiotacticity in the resulting polymer.

As used herein, the term “acrylate monomer” refers to an acrylate monomer which is optionally substituted by one or more hydrocarbyl groups as defined hereinabove.

Similarly, the term “alkylacrylate monomer” refers to an alkylacrylate monomer which is optionally substituted by one or more hydrocarbyl groups as defined hereinabove.

Preferably, said acrylate and alkylacrylate monomers are substituted by branched acyclic and cyclic hydrocarbons and/or functionalised substituents such as hydroxyalkyl, glycidyl and glycolethers.

In one preferred embodiment, the acrylate monomer is an allcylacrylate.

In another preferred embodiment, the alkylacrylate monomer is an alkylmethacrylate.

One preferred embodiment relates to the use of complexes in accordance with the second aspect of the invention as initiators in the preparation of block copolymers. By way of example, said complexes may be used in the preparation of a block copolymer of methyl methacrylate and n-butyl methacrylate. Further details of this aspect of the invention are provided in the accompanying examples section.

In a third aspect, the invention provides a process for the polymerisation of acrylate and/or allcylacrylate monomers, said process comprising contacting an initiating amount of a complex of formula Ia as defined above with an acrylate and/or an alkylacrylate monomer in the presence of a suitable solvent.

In a preferred embodiment, the invention provides a polymerisation process for preparing a block copolymer, for example, a block copolymer of methyl methacrylate and n-butyl methacrylate.

In a further preferred aspect, the polymerisation takes place in the presence of a chain transfer reagent.

Preferably, the chain transfer reagents have an acidic proton in the alpha position to a carbonyl group and are of the formula Z—CH₂—C(═O)—R″, wherein R″ is H, alkyl or aryl, and Z is selected from aryl, alkyl, H, amino, alkylamino, acyl, alkoxy (OR), thiol (SR) or heterocycle, where R is a hydrocarbyl group.

An example of a chain transfer reagent in which Z is aryl is 2′,4′,6′-trimethylacetophenone. Examples of chain transfer reagents in which Z is alkylamino include amino methyl ketones and amino ethyl ketones. An example of a chain transfer reagent in which Z is acyl is 2,4-pentanedione, i.e. Z is C(═O)CH₃ and R″ is CH₃.

Other suitable chain transfer reagents are known in the literature and will be apparent to the person skilled in the relevant art.

Preferably, the ratio of monomer to the complex in the above process is between 10:1 to 10⁶:1.

A fourth aspect of the invention provides an article prepared by the above-described process.

A fifth aspect of the invention provides a composition comprising an acrylate and/or an allcylacrylate monomer and a complex of formula Ia as defined above.

A sixth aspect of the invention provides a composition comprising poly(alkylacrylate) and/or poly(alkylmethacrylate) or co-polymers thereof, and a complex of formula Ia as defined above.

A seventh aspect of the invention relates to a process for preparing a complex of formula II as defined hereinabove, where X is alkyl, said process comprising reacting a compound of formula IX with (a) ⁿBuLi, and (b) XMgCl

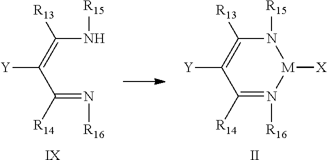

Alternatively, in an eighth aspect of the invention, the complex of formula II may be prepared by reacting a compound of formula IX with a di(alkyl)magnesium compound, MgX₂.

In a ninth aspect, the invention provides a process for preparing a complex of formula II, as defined above, where X is an enolate group of formula R¹⁰R¹¹C═CR¹²O—, said process comprising reacting the product obtained from the above-described seventh and eighth aspects with a compound of formula HR¹⁰C—C(O)R¹².

A tenth aspect of the invention provides a method for producing poly(alkylacrylate) or poly(alkylmethacrylate) having a syndiotacticity of greater than 75%, and preferably greater than 85%, said method comprising contacting the corresponding monomer (alkyl acrylate, or alkylmethacrylate, or mixtures thereof) with a complex of formula Ia as defined above in a suitable solvent.

Preferably, said method is carried out at a temperature in excess of −40° C.

Thus, in one particularly preferred embodiment, the complex of the invention is capable of affording polymethylmethacrylate with greater than 90% syndiotacticity in a highly controlled manner at a temperature in excess of −40° C.

The invention is further described by way of example and with reference to the following figures wherein:

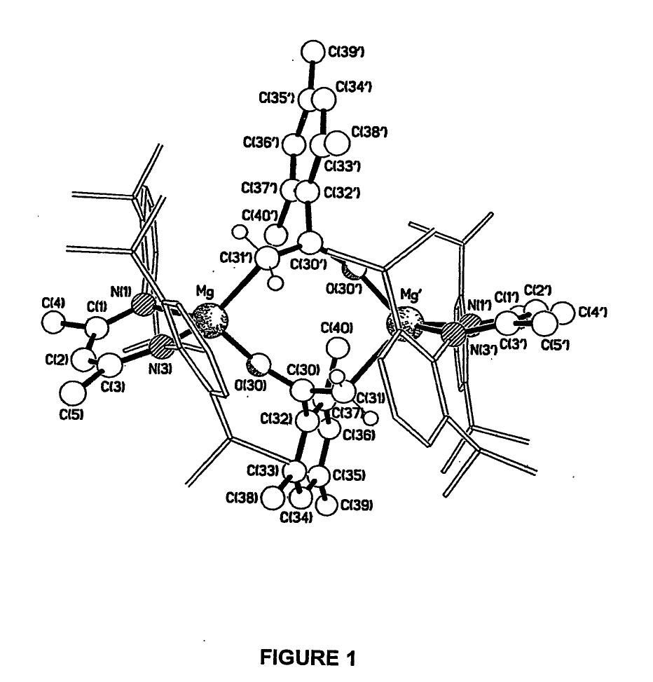

FIG. 1 shows the X-ray crystal structure for the compound [{HC(C(CH₃)═N-2,6-ⁱPr₂C₆H₃)₂}Mg(OC(═CH₂)Ar)]₂.

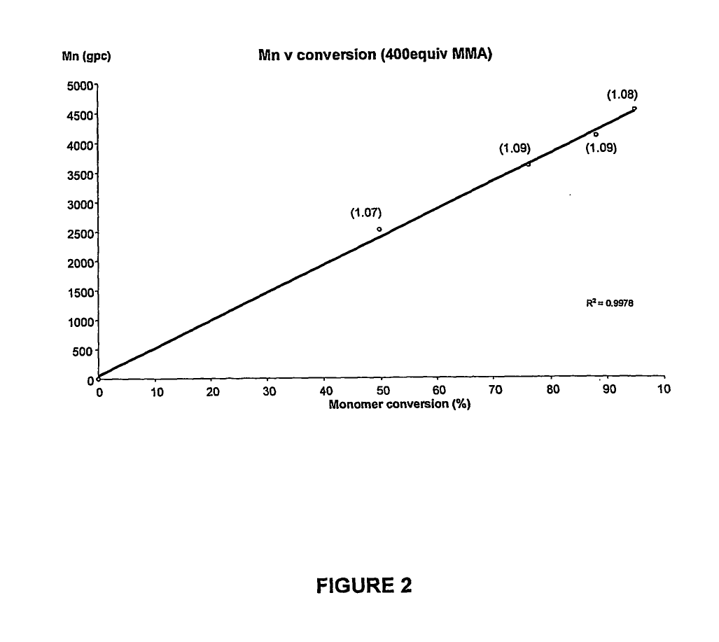

FIG. 2 shows a graph to illustrate the relationship between monomer conversion and Mₙ as determined by GPC (polydispersities, M_{w}/Mₙ, quoted in brackets).

### EXAMPLES

### Example 1

### Synthesis of {HC(C(CH₃)═B-2,6-ⁱPr₂C₆H₃)₂}MgⁱPr [1]

H₂C(C(CH₃)═N-2,6-ⁱPr₂C₆H₃)₂ (6.880 g, 1.64×10⁻² mol) was dissolved in 50 cm³ toluene and lithiated via the addition of 6.7 cm^{3 n}BuLi (2.5M in hexane, 1.68×10⁻² mol). In a separate vessel 8.4 cm^{3 i}PrMgCl (2.0M in Et₂O, 1.68×10⁻² mol) was diluted with 10 cm³ toluene and concentrated under reduced pressure to a white viscous liquid. This procedure was repeated in order to remove most of the Et₂O from the Grignard reagent to avoid formation of [{HC(C(CH₃)═N-2,6-ⁱPr₂C₆H₃)₂}MgⁱP.Et₂O]. The white sticky oil thus obtained was suspended in 20 cm³ toluene and this mixture was then added dropwise to the solution of {HC(C(CH₃)═N-2,6-ⁱPr₂C₆H₃)₂}Li to afford a pale yellow, cloudy suspension.

The reaction was stirred overnight (18 hours) at room temperature and then filtered. Volatiles were removed in vacuo and the resultant cream coloured solid was washed with 5 cm³ cold (−78° C.) n-pentane to afford 7.732 g of a slightly off-white powder (1.59×10⁻² mol, 97.0%).

¹H NMR (C₆D₆): δ 7.10 (m, 6H, m-H, p-H), 4.92 (s, 1H, HC{C(CH₃)NAr}₂), 3.13 (sept, 4H, ³J_{HH}=6.9 Hz, CHMe₂), 1.67 (s, 6H, HC{C(CH₃)NAr}₂), 1.26 (d, 12H, ³J_{HH}=6.9 Hz, CH(CH₃)₂), 1.14 (d, 12H, ³J_{HH}=6.9 Hz, CH(CH₃)₂), 0.86 (d, 6H, ³J_{HH}=6.6 Hz, MgCH(CH₃)₂), 0.13 (sept, 1H, ³J_{HH}=6.3 Hz, MgCH(CH₃)₂). ¹³C NMR (C₆D₆): δ 168.84 (HC{C(CH₃)NAr}₂), 143.63 (Cᵢₚₛₒ), 141.41 (Cₒᵣₜₕₒ), 125.71 (Cₚₐᵣₐ), 123.80 (Cₘₑₜₐ), 94.89 (HC{C(CH₃)NAr}₂), 28.39 (ArCH(CH₃)₂), 24.10 (HC{C(CH₃)NAr}₂), 24.02 (MgCH(CH₃)₂), 23.15 (ArCH(CH₃)₂), 9.22 (MgCH(CH₃)₂). Elemental analysis for C₃₂H₄₈N₂Mg: C 79.24, H 9.97, N 5.78%. Found C 79.31, H 9.94, N 5.68%.

### Example 2

### Synthesis of [{HC(C(CH₃)═N-2,6-ⁱPr₂C₆H₃)₂}Mg(OC(═CH₂)Ar)]₂ (Ar=2,4,6,-Me₃C₆H₂) [2]

0.8240 g {HC(C(CH₃)═N-2,6-ⁱPr₂C₆H₃)₂}MgⁱPr (1.70×10⁻³ mol) was suspended in 20 cm³ toluene in a Schlenk tube placed in a solid CO₂/acetone slush bath at −78° C. A 5 cm³ toluene solution of 2′,4′,6′-trimethylacetophenone (0.2756 g, 1.70×10⁻³ mol), also at −78° C., was then added dropwise over 5 minutes to afford a dark orange solution. On warming to ambient temperature the solution becomes increasingly pale yellow.

The reaction was stirred at room temperature for 18 hours. Removal of volatiles from the pale yellow-green solution gave a white solid which was then washed with 10 cm³ cold heptane (−78° C.). A saturated solution was then prepared by stirring the residual white powder in 15 cm³ heptane at 60° C. for 30 minutes. The solution was filtered and allowed to slowly cool to yield very pale yellow rhomboid crystals of X-ray diffraction quality.

A second crop was prepared by reducing the volume of the mother liquor to approximately two-thirds and storing overnight in a freezer at −10° C. Total yield: 0.673 g, 5.58×10⁻⁴ mol, 65.7%

### Example 3

### Synthesis of [{HC(C(CH₃)=N-2,6-ⁱPr₂C₆H₃)₂}Mg(OC(═CH2)Ar).Et₂O] (Ar=2,4,6,-Me₃C₆H₂) [3]

A chilled (−78° C.) 10 cm³ Et₂O solution of 2′,4′,6′-trimethylacetophenone (0.4156 g, 2.56×10⁻³ mol) was added dropwise over 30 minutes to a 10 cm³ Et₂O solution of {HC(C(CH₃)═N-2,6-ⁱPr₂C₆H₃)₂}MgⁱPr (1.2315 g, 2.54×10⁻³ mol) in a solid CO₂/acetone slush bath at −78° C. The reaction was allowed to warm to room temperature to give a pale yellow coloured solution, which was then stirred for a further 18 hours. Volatiles were removed in vacuo to give a sticky, cream-coloured solid which was washed with 5 cm³ pentane at −78° C. to yield 1.312 g of a white powder (1.94×10⁻³mol, 76.3%).

### Example 4

### Typical Polymerisation Procedure for [{HC(C(CH₃)═N-2,6ⁱPr₂C₆H₃)₂}Mg(OC(═CH₂)Ar)]₂ [2]

0.0084 g [{HC(C(CH₃)═N-2,6-ⁱPr₂C₆H₃)₂}Mg(OC(═CH₂)Ar)]₂ (1.39×10⁻⁵ mol) was weighed out into a glass vial and dissolved in 5 cm³ toluene to afford a pale yellow solution. The solution was cooled to −30° C. Methyl methacrylate (0.4183 g, 4.18×10⁻³ mol, 300 equivalents) was then weighed out and cooled to −30° C. and added to the initiator solution. The mixture was stirred for 10 minutes, followed by termination of the polymerisation by addition of 25 μl MeOH.

GPC analysis was performed on a small aliquot, which was removed and dried in vacuo. The remainder of the solution was added to a large excess (ca. 150 cm³) MeOH, and the precipitate was collected and dried. ¹H NMR analysis (CDCl₃) gave 92% rr, 8% rm, (mm triad undetected).

### Example 5

### Typical Polymerisation Procedure for [{HC(C(CH₃)═N-2,6-ⁱPr₂C₆H₃)₂}Mg(OC (═CH₂)Ar).Et₂O]₂ [3]

An identical method to that described above was employed. No significant differences in the behaviour of the polymerisation using the etherate initiator were observed.

### Example 6

### Typical Polymerisation Procedure for [{HC(C(CH₃)═N-2,6-ⁱPr₂C₆H₃)₂})MgⁱPr] [1]

An identical method to the procedure outlined for [{HC(C(CH₃)═N-2,6-ⁱPr₂C₆H₃)₂}Mg(OC(═CH₂)Ar)]₂ was used. Immediately upon addition of methyl methacrylate to the initiator solution a bright yellow colouration was observed, which quickly became pale yellow. This colour persisted through the remainder of the reaction, disappearing upon addition of MeOH.

### Example 7

### Investigation into the Relationship Between Conversion and Molecular Weight

Using a similar method to that described above, 0.0080 g [{HC(C(CH₃)═N-2,6-ⁱPr₂C₆H₃)₂}Mg(OC(═CH₂)Ar)]₂ (1.33×10⁻⁵ mol) was dissolved in 6 cm³ CDCl₃. To this solution at −30° C. was added neat methyl methacrylate (0.5317 g, 5.31×10-3 mol, 400 equivalents). The reaction was stirred at −30° C. and at set time periods (120, 240, 360 and 480 seconds), 0.35 cm³ aliquots were removed and immediately terminated by addition to 20 μl MeOH.

Monomer conversion was calculated by diluting the samples with a further 0.35 cm³ CDCl₃ and integrating the ¹ NMR resonances of the OCH₃ signals of the monomer (δ3.71) versus the polymer (δ3.56). Volatiles were then removed in vacuo and the residue was dissolved in non-deuterated CHCl₃. Analysis of this solution by gel permeation chromatography afforded a correlation of Mₙ versus conversion (see FIG. 2).

### Example 8

### Block Copolymerisation of n-Butylmethacrylate (BMA) and Methylmethacrylate (MMA)

0.0106 g [{HC(C(CH₃)═N-2,6-ⁱPr₂C₆H₃)₂}Mg(OC(═CH₂)Ar)]₂ (1.76×10⁻⁵ mol) was dissolved in 3 cm³ CDCl₃ at −30° C. To this stirring solution was added 0.2526 g BMA (1.78×10⁻⁵ mol, 101 equivalents). After 10 minutes a 300 μl aliquot was removed and terminated by addition to 100 MeOH. The polymerisation was allowed to stir for a further 60 seconds and then 0.1756 g MMA (1.75×10⁻⁵ mol, 100 equivalents) was added. The reaction was stirred for a further 10 minutes and terminated by addition of 25 μl MeOH. ¹H NMR on the aliquot revealed that before the addition of the second monomer the BMA had been totally consumed.

GPC on the aliquot before addition of the MMA showed a single, monodisperse peak (Mn calc=14,400, Mn obs=13,800, Mw/Mn=1.12). GPC on the block copolymer demonstrated Mn increased upon the incorporation of the MMA (Mn calc=24,400, Mn obs=22,800, Mw/Mn=1.50).

### Example 9

### The Use of 2′,4′,6′-Trimethylacetophenone as a Chain Transfer Agent

To a 3 cm³ CDCl₃ solution of [{HC(C(CH₃)═N-2,6-ⁱPr₂C₆H₃)₂}Mg(OC(═CH₂)Ar)]₂

(0.0130 g, 2.16×10⁻⁵mol) at −30° C. was added 17.9 μl 2′,4′,6′-trimethylacetophenone (1.08×10⁻⁴ mol, 5.0 equivalents) to afford a bright yellow solution. 0.8675 g MMA (8.66×10⁻⁵ mol, 402 equivalents) was then added. After 30 minutes the reaction was terminated by the addition of 25 μl MeOH. GPC Mn calc (assuming maximum chain transfer)=6,700; Mn obs=7,200, Mw/Mn=2.83).

### Example 10

### Synthesis of {HC(C(^{t}Bu)═N-2,6-ⁱPr₂C₆H₃)₂}Mg(OC(═CH₂)-2,4,6-Me₃C₆H₂) [4]

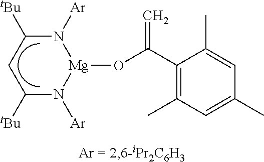

0.8902 g H₂C(C(^{t}Bu)═N-2,6-ⁱPr₂C₆H₃)₂ (1.77×10⁻³ mol) was dissolved in 10 cm³ toluene and then chilled to −78° C. Bu₂Mg (1.86 cm³, 1.0M solution in heptane, 1.86×10⁻³ mol, 1.05 equivalents) was added dropwise over 5 minutes, and upon removal from the cold bath a light yellow solution developed. The reaction was allowed to reach room temperature and then stirred for 2 hours at 60° C. The reaction vessel was then allowed to cool to room temperature before 0.30 cm³ 2′,4′,6′-trimethylacetophenone (1.81×10⁻³ mol, 1.02 equivalents) was added. The mixture was then warmed back to 60° C. and stirred for 90 mins. The volatile components were then removed in vacuo to give a yellow oily solid which was washed with pentane (5 cm³) at −78° C.

¹H NMR (C₆D₆): δ 7.12-6.97 (m, 6H, N-2,6-ⁱPr₂C₆H₃), 6.72 (s, 2H, 2,4,6-Me₃C₆H₂), 5.40 (s, 1H, HC{C(^{t}Bu)═NAr}₂), 3.77 (d, ²J_{HH}=0.9 Hz, 1H, OC(═CHH)Ar′), 3.66 (d, ²J_{HH}=1.0 Hz, 1H, OC(═CHH)Ar′), 3.22 (sept, 4H, ³J_{HH}=6.9 Hz, CHMeMe) 2.17 (s, 6H, mesityl o-CH₃), 1.98 (s, 3H, mesityl p-CH₃), 1.22 (d, 12H, ³J_{HH}=6.8 Hz, CHMeMe), 1.21 (d, 12H, ³J_{HH}=6.98 Hz, CHMeMe), 1.14 (s, 18H, HC{C(CMe₃)═NAr}₂).

### Example 11

### Use of {HC(C(^{t}Bu)═N-2,6-ⁱPr₂C₆H₃)₂}Mg(OC(═CH₂)-2,4,6-Me₃C₆H₂) ]4] as an MMA Polymerisation Initiator

A similar method to that described for the synthesis of {HC(C(Me)═N-2,6-ⁱPr₂C₆H₃)₂}Mg(OC(═CH₂)-2,4,6-Me₃C₆H₂) was used. The polymerisation using {HC(C(^{t}Bu)═N-2,6-ⁱPr₂C₆H₃)₂}Mg(OC(═CH₂)-2,4,6-Me₃C₆H₂) is slower, however. Thus, for 200 equivalents MMA a reaction time of 120 minutes is required at −30° C. to afford x% conversion (c.f. <5 minutes for {HC(C(Me)═N-2,6-ⁱPr₂C₆H₃)₂}Mg(OC(═CH₂)-2,4,6-Me₃C₆H₂).

Mₙ=17,100 (Mₙ calc=20,000); M_{w}/Mₙ=1.04.

Syndiotactic content (% rr triad)=90%

### Example 12

### Synthesis of {HC(C(Me)═N-2,6-ⁱPr₂C₆H₃)(C(Me)═N-2-OMeC₆H₄)}MgⁱPr [5]

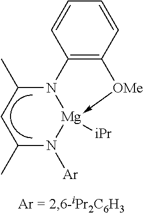

ⁿButyl lithium (2.70 mL, 2.5M in hexanes, 6.75×10⁻³ mol) was added slowly to a stirred solution of {H₂C(C(Me)═N-2,6-ⁱPr₂C₆H₃)(C(Me)═N-2-OMeC₆H₄)} (2.46 g, 6.75×10⁻³ mol) in 25 mL toluene at 0° C. The solution was stirred for 24 hours before addition of ⁱPrMgCl (3.37 cm³, 2.0M in Et₂O, 6.74×10⁻³ mol) at 0° C. The solution was then stirred for a further 18 hours at ambient temperature. Concentration of the solution under reduced pressure afforded an orange solid (2.1 g, 4.98×10⁻³ mol, 73.9%).

¹H NMR (C₆D₆): δ 6.87, 6.79, 6.48 (m, 7H, ArH), 4.90 (s, 1H, HC{C(CH₃)NAr}₂), 3.32 (s, 3H, ArOCH₃), 3.20 (sept, 1H, ³J_{HH}=6.86 Hz, ArCHMe₂), 1.92 (s, 3H, HC{C(CH₃)NAr}₂), 1.68 (s, 3H, HC{C(CH₃)NAr}₂), 1.24 (d, 6H, ³J_{HH}=6.44 Hz, ArCH(CH₃)₂), 1.23 (d, 6H, ³J_{HH}=7.86 Hz, MgCH(CH₃)₂), 1.16 (d, 6H, ³J_{HH}=6.83 Hz, ArCH(CH₃)₂), 0.07 (sept, 1H, ³J_{HH}=7.83 Hz, MgCHMe₂).

### Example 13

### Use of {HC(C(Me)═N-2,6-ⁱPr₂C₆H₃)(C(Me)═N-2-OMeC₆H₄)}MgⁱPr as an MMA Polymerisation Initiator

In toluene at −30° C., 200 equivalents MMA attains a conversion of 74% after 120 seconds.

Mₙ=24,677 (Mₙ calc=14,800), M_{w}/Mₙ=1.20

Syndiotactic content (% rr triad)=85%

### Example 14

### Synthesis of {HB(3,5-Me₂C₃N₂H)₃}Mg(OC(═CH₂)-2,4,6-Me₃C₆H₂) [6]

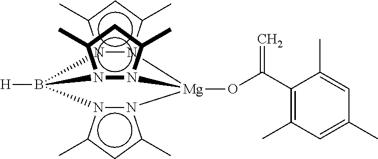

Potassium tris(3,5-dimethylpyrazolyl)borate (0.8945 g, 2.66×10⁻³ mol) was suspended in 20 cm³ THF. 1.36 cm^{3 i}PrMgCl (2.0M in Et₂O, 2.72×10⁻³ mol, 1.02 equivalents) was added via syringe at room temperature and the resultant white suspension was stirred for 6 hrs at 60° C. The reaction mixture was then allowed to cool to room temperature before a 10 cm³ THF solution of 0.4401 g 2′,4′,6′-trimethylacetophenone (2.71×10⁻³ mol, 1.02 equivalents) was added dropwise over 2 minutes. The reaction was stirred at room temperature for 16 hours, filtered and concentrated to a white solid. This was washed with 5 cm³ cold pentane (−78° C.) and dried in vacuo to afford a free flowing white powder. ¹H NMR. (CDCl₃): δ 6.83 (s, 2H, 2,4,6-Me₃C₆H₂), 4.19 (d, ²J_{HH}=0.8 Hz, 1H, OC(═CHH)Ar′), 3.70 (d, ²J_{HH}=0.9 Hz, 1H, OC(═CHH)Ar′), 3.70 (s, br, BH), 2.47 (s, 6H, mesityl o-CH₃), 2.35 (s, 9H, HB{C₃N₂H(CH₃)₂}), 2.26 (s, 3H, mesityl p-CH₃), 2.22 (s, 9H, HB{C₃N₂H(CH₃)₂})

### Example 15

Use of {HB(3,5-Me₂C₃N₂H)₃}Mg(OC(═CH₂)-2,4,6-Me₃C₆H₂) [6] as an MMA Polymerisation Initiator

0.0080 g {HB(3,5-Me₂C₃N₂H)₃}Mg(OC(═CH₂)-2,4,6-Me₃C₆H₂) (1.66×10⁻⁵ mol) was dissolved in 2 cm³ toluene and chilled to −30° C. To this solution was added a 1 cm³ toluene solution of MMA (0.3360 g, 3.36×10⁻³ mol, 202 equivalents) and the reaction was stirred for 2 hours at −30° C.

Mₙ=31,100 (calc=20,200), M_{w}/Mₙ=1.52

Triad analysis (by ¹H NMR): 14.5% mm 20.5% rm : 65.0% rr

### Example 16

### Synthesis of {HC(C(Me)═N-2,6-ⁱPr₂C₆H₃)₂}Ca(OC(═CH₂)-2,4,6-Me₃C₆H₂0.THF [7]

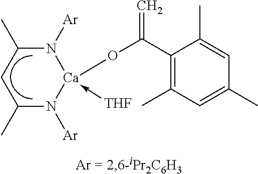

{HC(C(Me)═N-2,6-ⁱPr₂C₆H₃)₂}CaNTMS₂.THF (0.0089 g, 1.29×10⁻⁵ mil) and 2′,4′,6′-trimethylacetophenone (0.0021 g, 1.29×10⁻⁵ mol) were mixed together in THF-d₈. ¹H NMR spectroscopy confirms the formation of {HC(C(Me)═N-2,6-ⁱPr₂C₆H₃)₂}Ca(OC(═CH₂)-2,4,6-Me₃C₆H₂).THF and HNTMS₂.

¹H NMR (THF-d₈): δ 7.06 (m, br, 6H, N-2,6-ⁱPr₂C₆H₃), 6.60 (s, br, 2H, 2,4,6Me-₃C₆H₂), 4.85 (s, br, 1H, HC{C(^{t}Bu)═NAr}₂), 4.73 (s, br, 1H, OC(═CHH)Ar′), 3.4 (s, br, 1H, OC(═CHH)Ar′), 3.17 (m, br, 4H, CHMeMe), 2.16 (s, br, 6H, mesityl o-CH₃), 1.70 (s, br, 6H, HC{C(CMe)═NAr}₂), 1.60 (s, 3H, mesityl p-CH₃), 1.11 (m, br, 24H, ³J_{HH}=6.8 Hz, CHMe₂).

### Example 17

### Synthesis of [{HC(C(me)═N-2,6-ⁱPr₂C₆H₃)₂}Ca(OC(═CH₂-2,4,6-Me₃C₆H₂)]ₙ [8]

Mixing {HC(C(Me)═N-2,6-ⁱPr₂C₆H₃)₂}CaNTMS₂.THF (0.0219 g, 3.17×10⁻⁵ mol) and 2′,4′,6′-trimethylacetophenone (0.0051 g, 3.17×10⁻⁵ mol) in benzene-d₆ affords [{HC(C(Me)═N-2,6-ⁱPr₂C₆H₃)₂}Ca(OC(═CH₂)-2,4,6-Me₃C₆H₂)]ₙ.

¹H NMR (C₆D₆):δ 7.19-7.06 (m, 6H, N-2,6-ⁱPr₂C₆H₃), 6.65 (s, 2H, 2,4,6-Me₃C₆H₂), 4.62 (s, 1H, HC{C(^{t}Bu)═NAr}₂), 4.18 (s, br, 1H, OC(═CHH)Ar′), 3.83 (s, br, 1H, OC(═CHH)Ar′), 3.12, 3.04 (sept, 4H, ³J_{HH}=6.9 Hz, CHMeMe), 2.10 (s, 6H, mesityl o-CH₃), 1.98 (s, 3H, mesityl p-CH₃), 1.53 (s, 6H, HC{C(Me)═NAr}₂), 1.16-1.08 (m, br, 24H, CHMeMe)

### Example 18

### Use of [{HC(C(Me)═N-2,6-ⁱPr₂C₆H₃)₂}Ca(OC(═CH₂)-2,4,6-Me₃C₆H₂)]ₙ [8] as an MMA Polymerisation Initiator

At −30° C. a 0.5 cm³ toluene solution of 2′,4′,6′-trimethylacetophenone (0.0022 g, 1.36×10⁻⁵ mol) was added to a 2 cm³ toluene solution of {HC(C(Me)═N-2,6-ⁱPr₂C₆H₃)₂}CaNTMS₂.THF (0.0091 g, 1.32×10⁻⁵ mol). After stirring for 1 MMA (0.2657 g, 2.65×10⁻³ mol, 201 equivalents in 1 cm³ toluene) was added dropwise over 20 s.

The polymerisation was stirred at −30° C. for 5 minutes, then terminated with MeOH (25 μl).

¹H NMR confirms that the PMMA is isotactic-biased: triad contents=70.8% mm: 22.7% mr: 6.5% rr

Mₙ=41,850, M_{w}/Mₙ=6.09

### Example 19

### Synthesis of {HC(C(CH₃═N-2,6-ⁱPr₂C₆H₃)₂}MgNPrⁱ₂ [9]

A stirred toluene solution of 2.0×10⁻³ mol [(BDI)Mg^{n/s}Bu] (formed in situ from the reaction of Bu₂Mg with H₂C(C(CH₃)═N-2,6-ⁱPr₂C₆H₃)₂) was cooled to −30° C. and treated dropwise with ⁱPr₂NH (290 μl, 2.1×10⁻³ mol). The resulting solution was allowed to warm to ambient temperature, and then stirred at 60° C. for 15 minutes. Volatiles were then removed in vacuo and the residue then extracted into pentane (35 ml). Upon standing at −30° C. 0.67 g crystals formed (62%).

¹H NMR (C₆D₆): δ 7.12 (m, 6H, m-H, p-H), 4.84 (s, 1H, HC{C(CH₃)NAr}₂), 3.23 (sept, 4H, ³J_{HH}=6.7 Hz, CHMe₂), 3.07 (sept, 2H, ³J_{HH}=6.1 Hz, NCH(CH₃)₂), 1.66 (s, 6H, HC{C(CH₃)NAr}₂), 1.34 (d, 12H, ³J_{HH}=6.9 Hz, CH(CH₃)₂), 1.17 (d, 12H, ³J_{HH}=6.9 Hz, CH(CH₃)₂), 0.87 (d, 12H, ³J_{HH}=6.1 Hz, NCH(CH₃)₂).

### Example 20

### Use of {HC(C(CH₃)═N-2,6-ⁱPr₂C₆H₃)₂}MgNPrⁱ₂ [9] as an MMA Polymerisation Initiator

In toluene at −30° C., 200 equivalents MMA were mixed with {HC(C(CH₃)=N-2,6-ⁱPr₂C₆H₃)₂}MgNPrⁱ₂. The polymerisation was terminated after 90seconds with MeOH. A conversion of 94% was measured by ¹H NMR spectroscopy.

Mₙ=19,550 (Mₙ calc=18,800); M_{w}/Mₙ=1.05.

Syndiotactic content (% rr triad) >90%

Various modifications and variations of the described methods of the invention will be apparent to those skilled in the art without departing from the scope and spirit of the invention. Although the invention has been described in connection with specific preferred embodiments, various modifications of the described modes for carrying out the invention which are obvious to those skilled in chemistry or related fields are intended to be within the scope of the following claims.

1. A complex of formula I 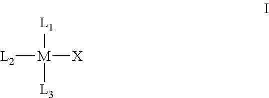
wherein
M is Ca, Mg, Ba or Sr;
L₁ is selected from R¹O, R²S, R³R⁴N, R⁵R⁶P, a substituted or unsubstituted cyclopentadienide and a substituted or unsubstituted pyrazolyl group, where R¹⁻⁶ are each independently H or hydrocarbyl;
L₂ is selected from R⁷R⁸O, R⁷R⁸S, R⁷R⁸R⁹N, R⁷R⁸C═NR⁹, PR⁷R⁸R⁹, or a substituted or unsubstituted heterocycle containing one or more O, N or S atoms, where R⁷⁻⁹ are each independently H or a hydrocarbyl group;
or L₁ and L₂ are linked to form a bidentate ligand;
L₃ is absent or is a solvent molecule, or a neutral ligand as defined for L₂, wherein L₃ may be the same or different to L₂; or L₃ is linked to a further metal centre; or L₁, L₂ and L₃ are linked to form a tridentate ligand; and
X is an alkyl group, an aryl group, an amide group, an aryloxide or an enolate group of formula R¹⁰R¹¹C═CR¹²O—, wherein R¹⁰⁻¹² are each independently H or hydrocarbyl;
with the proviso that when L₁ and L₂ are {HC(C(CH₃)═N-2,6-ⁱPr₂C₆H₃)₂} and M is magnesium, X is other than Me or ^{t}Bu.

2. A complex according to claim 1 wherein R¹ and R² are hydrocarbyl, and R³⁻⁶ are H or hydrocarbyl.

3. A complex according to claim 1 wherein R¹ and R² are each independently selected from branched or unbranched alkyl, branched or unbranched alkenyl, or aryl, each of which may be substituted or unsubstituted.

4. A complex according to claim 1 wherein L₁ and L₂ are linked to form a bidentate ligand selected from a beta-diketiminate and a beta-ketoiminate.

5. A complex according to claim 4 of formula II or III 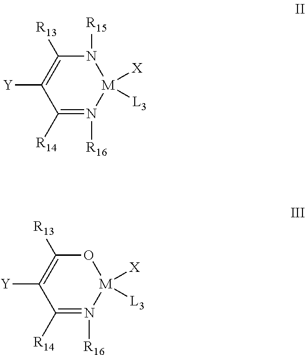
wherein
Y is H, hydrocarbyl or CN;
R¹³⁻¹⁶ are each independently selected from H and hydrocarbyl; or Y and
R¹³ are linked to form a hydrocarbyl group; and
L₃ absent or as defined in claim 1.
A complex according to claim 5 wherein Y is selected from H, CN, alkyl, aryl, haloalkyl or heteroalkyl;
R¹³⁻¹⁶ are each independently selected from alkyl, aryl, heteroalkyl, haloalkyl, cycloalkyl and a heterocyclic ring containing at least one O, N or S atom; or Y and R¹³ are linked to form an aryl group; and
L₃ is absent or is selected from R⁷R⁸O, R⁷R⁸S, R⁷R⁸R⁹N, R⁷C═NR⁸ , PR⁷R⁸R⁹, thiophene and tetrahydrofuran, where R⁷⁻⁹ are each independently H or a hydrocarbyl group.

6. A complex according to claim 1 of formula V 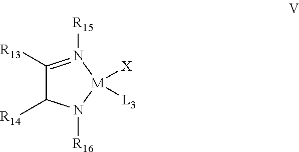
wherein R¹³⁻¹⁶ are each independently selected from H, hydrocarbyl, alkyl, aryl, heteroalkyl, haloalkyl, cycloalkyl, and a heterocyclic ring containing at least one O, N or S atom, and where R¹³ and R¹⁵ are optionally linked to form an aryl group.

8. A complex according to claim 1 wherein L₁ and L₂ form a bidentate ligand of formula VIII 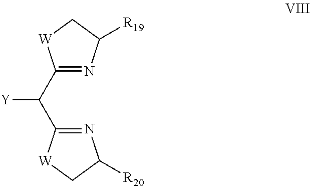
wherein
Y is as defined above;
W is O, NH, NR′ or CH₂ where R′ is hydrocarbyl; and
R¹⁹⁻²⁰ are as defined for R¹³⁻¹⁶ above.

9. A complex according to claim 1 wherein L₁, L₂ and L₃ are linked to form a tridentate ligand.

10. A complex according to claim 9 wherein L₁, L₂ and L₃ are linked to form a tridentate ligand selected from a beta-diketiminate with a pendant donor group, and a Schiff base derivative with a pendant donor arm.

11. A complex according to claim 10 of formula VI 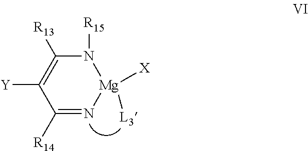
wherein L₃′ is a solvent molecule or a neutral ligand, and is linked to the nitrogen of the bidentate ligand via a linker group.

12. A complex according to claim 10 wherein said complex is of formula VII 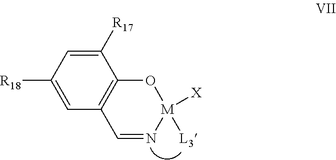
wherein L₃′ a solvent molecule or a neutral ligand and is linked to the nitrogen of the bidentate ligand via a linker group, and R¹⁷⁻¹⁸ are each independently selected from H and hydrocarbyl.

13. A complex according to claim 11 wherein the linker group is (CH₂)ₙ where n is 0-6, an arylene group, or SiR₂, where R is hydrocarbyl.

14. A complex according to claim 1 of formula X 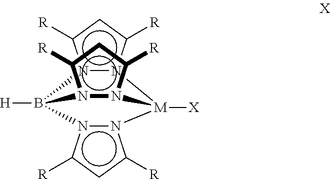
wherein each R is independently H or a hydrocarbyl group.

15. A compound according to claim 1 wherein X is an alkyl group

16. A compound according to claim 15 wherein X is ⁱPr.

17. A compound according to claim 1 wherein X is an amide group.

18. A compound according to claim 17 wherein X is NPrⁱ₂.

19. A compound according to claim 1 wherein X is an enolate group of formula R¹⁰R¹¹C═CR¹²O—, wherein R¹⁰ and R¹¹ are H and R¹² is an aryl group.

20. A compound according to claim 19 wherein X is —OC (═CH₂)Ar, wherein Ar is 2,4,6,-Me₃C₆H₂.

21. A complex comprising a dimer of a complex according to claim 1.

22. A complex according to claim 1 selected from the following:
{HC(C(CH₃)═N-2,6-ⁱPr₂C₆H₃)₂}MgⁱPr [1];
[{HC(C(CH₃)═N-2,6-ⁱPr₂C₆H₃)₂}Mg(OC(═CH₂)Ar)]₂ ]2];
[{HC(C(CH₃)═N-2,6-ⁱPr₂C₆H₃)₂}Mg(OC(═CH2)Ar.Et₂O] [3];
wherein Ar=2,4,6,-Me₃C₆H₂;
{HC(C(^{t}Bu)═N-2,6-ⁱPr₂C₆H₃)₂}Mg(OC(═CH₂)-2,4,6-Me₃C₆H₂) [4];
{HC(C(Me)═N-2,6-ⁱPr₂C₆H₃)(C(Me)═N-2-OMeC₆H₄)}MgⁱPr [5];
{HB(3,5-Me₂C₃N₂H)₃}Mg(OC(═CH₂)-2,4,6-Me₃C₆H₂) [6];
{HC(C(Me)═N-2,6-ⁱPr₂C₆H₃)₂}Ca(OC(═CH₂)-2,4,6-Me₃C₆H₂).THF [7];
[{HC(C(Me)═N-2,6-ⁱPr₂C₆H₃)₂}Ca(OC(═CH₂)-2,4,6-Me₃C₆H₂)]ₙ [8] where n=1 or 2; and
{HC(C(CH₃)═N-2,6-ⁱPr₂C₆H₃)₂}MgNPrⁱ₂ [9].

23. A method of initiating polymerization comprising introduction of a complex of formula Ia as a polymerisation initiator, 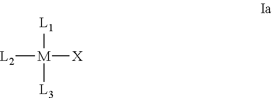
wherein
M is Ca, Mg, Ba or Sr;
L₁ is selected from R¹O, R²S, R³R⁴N, R⁵R⁶P, a substituted or unsubstituted cyclopentadienide, and a substituted or unsubstituted pyrazolyl group, where R¹⁻⁶ are each independently H or hydrocarbyl;
L₂ is selected from R⁷R⁸O, R⁷R⁸S, R⁷R⁸R⁹N, R⁷R⁸C═NR⁹, PR⁷R⁸R⁹, and a substituted or unsubstituted heterocycle containing one or more O, N or S atoms, where R⁷⁻⁹ are each independently H or a hydrocarbyl group; or L₁ and L₂ are linked to form a bidentate ligand;
L₃ is absent or is a solvent molecule, or a neutral ligand as defined for L₂, wherein L₃ may be the same or different to L₂; or L₃ is linked to a further metal centre; or L₁, L₂ and L₃ are linked to form a tridentate ligand; and
X is an alkyl group, an aryl group, an amide group, or an enolate group of formula R¹⁰R¹¹C═CR¹²O—, wherein R¹⁰⁻¹² are each independently H or hydrocarbyl;
with the proviso that when L₁ and L₂ are {HC(C(CH₃)═N-2,6-ⁱPr₂C₆H₃)₂}, M is magnesium, X is other than Me or ^{t}Bu.

24. The method of claim 23 comprising the polymerisation of acrylate and/or alkyl acrylate monomers.

25. The method of claim 23 further comprising the use of a chain transfer reagent.

26. A process for the polymerisation of acrylate and/or alkylacrylate monomers, said process comprising contacting an initiating amount of a complex of formula Ia as defined in claim 23 with an acrylate and/or an alkylacrylate monomer in the presence of a suitable solvent.

27. A process according to claim 26 wherein the ratio of monomer to the complex is between 10:1 and 10⁶:1.

28. (canceled)

29. A composition comprising an acrylate and/or an alkylacrylate monomer and a complex of formula Ia as defined in claim 23.

30. A composition comprising poly(alkylacrylate) and poly(alkylmethacrylate) or copolymers thereof, and a complex of formula Ia as defined in claim 23.

31. A process for preparing a complex of formula II as defined in claim 5, where X is alkyl, said process comprising reacting a compound of formula IX with (a) ⁿBuLi, and (b) XMgCl

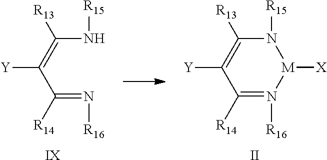

32. A process for preparing a complex of formula II as defined in claim 5, where X is alkyl, said process comprising reacting a compound of formula IX with MgX₂

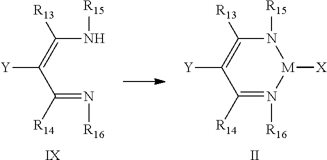

33. A process for preparing a complex of formula II, as defined in claim 5, where X is an enolate group of formula R¹⁰R¹¹C═CR¹²O—, said process comprising reacting the product obtained from the process of claim 31 or claim 32 with a compound of formula HR¹⁰R¹¹C—C(O)R¹².

34. A method for producing polymethacrylate having greater than 75% syndiotacticity, said method comprising contacting methacrylate monomer with a complex of formula Ia as defined in claim 23 in the presence of a suitable solvent.

35. A method according to claim 34 which is carried out at a temperature in excess of −40° C.
